(19) United States
(12) Patent Application Publication
(10) Pub. No.: US 2003/0159249 A1
(43) Pub. Date: Aug. 28, 2003

(54) Hinge device

(75) Inventor: Lin Tsung-Lung, Kaohsiung Hsien (TW)

Correspondence Address: Bacon & Thomas, 4th Floor, 625 Slaters Lane, Alexandria, VA, 22314, US

(73) Assignee: King Slide Works Co., Ltd., Kaohsiung Hsien (TW)

(21) Appl. No.: 10/083,539

(22) Filed: Feb. 27, 2002

(51) Int. Cl. E05D 11/06

(52) U.S. Cl. 16/371

(57) ABSTRACT

A hinge device comprises a main plate, a mounting member, a first arm, and a second arm X-hinged to the first arm. The first arm includes a first end pivoted to the main plate and a second end pivoted to the mounting member. The second arm includes a first end pivoted to the main plate and a second end pivoted to an end of a connecting member. The other end of the connecting member is pivoted to the mounting member. When the hinge device is moved to an open state, an engaging member pivoted to the connecting member moves across a lobe of a positioning block fixed to the mounting member. When the hinge device is in a closed state, the protrusion of the engaging member is engaged in a retaining groove of the positioning block.

### BACKGROUND OF THE INVENTION

1. Field of the Invention

The present invention relates to a hinge device. In particular, the present invention relates to a durable hinge device having an opening angle greater than 90°.

2. Description of the Related Art

FIGS. 1 and 2 of the drawings illustrate a conventional hinge device having an opening angle greater than 90°. The hinge device comprises a first mounting plate 91 fixed to a wall and a second mounting plate 92 fixed to a door. A bottom plate 93 is mounted to the first mounting plate 91. A first arm 94 and a second arm 95 are X-hinged by a pivotal member 96. An end of the pivotal member 96 is connected to the bottom plate 93 through a connecting member 97. The other end of the first arm 94 is connected to the bottom plate 93 through another connecting member 98. An end of the second arm 95 is pivoted by a pivotal member 99 to an end of a return plate 90. The other end of the return plate 90 is pivoted by a pivotal member 901 to the second mounting plate 92. A return arm 902 is mounted in the return plate 90 and includes an end pivoted to the pivotal member 901. An elastic element 903 is mounted around the return arm 902. When the hinge device is in a closed state shown in FIG. 2, an extension 904 of the return arm 902 extends into a positioning hole 971 of the connecting member 97 to thereby retain the hinge device in place. However, it was found that the pivotal member 901 bent after a period of time under the action of the elastic element 903. As a result, the hinge device would be stuck and thus could not be used.

### SUMMARY OF THE INVENTION

It is the primary object of the present invention to provide a durable hinge device.

A hinge device in accordance with the present invention comprises a main plate, a mounting member, a first arm, a second arm, and a return device. A connecting plate includes a first end pivoted to an intermediate portion of the main plate and a second end. The first arm includes a first end pivoted to the second end of the connecting plate and a second end pivoted to the mounting member. The second arm includes an intermediate portion pivoted to an intermediate portion of the first arm. A first end of the second arm is pivoted to an end of the main plate. A positioning block is fixed to the mounting member and includes a lobe and a retaining groove. The return device comprises a connecting member, an elastic element, and an engaging member. The connecting member includes a first end pivoted to the second end of the second arm. The connecting member further includes a second end pivoted to mounting member. The engaging member is pivoted to an intermediate portion of the connecting member and includes a lobe and a protrusion. The elastic element is attached between the connecting member and the lobe of the engaging member.

When the hinge device is moved to an open state, the engaging member moves across the lobe of the positioning block. When the hinge device is in a closed state, the protrusion of the engaging member is engaged in the retaining groove of the positioning block.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is a schematic sectional view of a conventional hinge device in an open state.

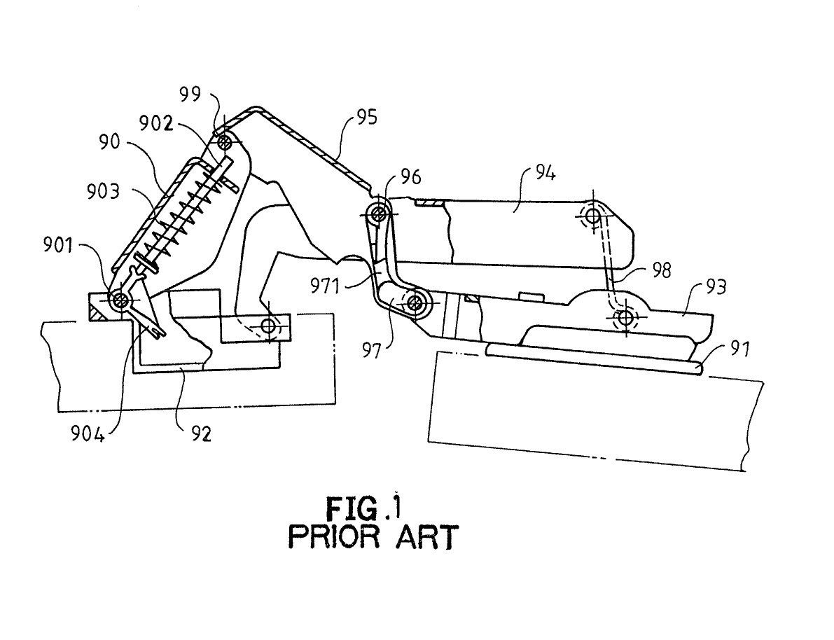

FIG. 2 is a sectional view of the conventional hinge device in a closed state.

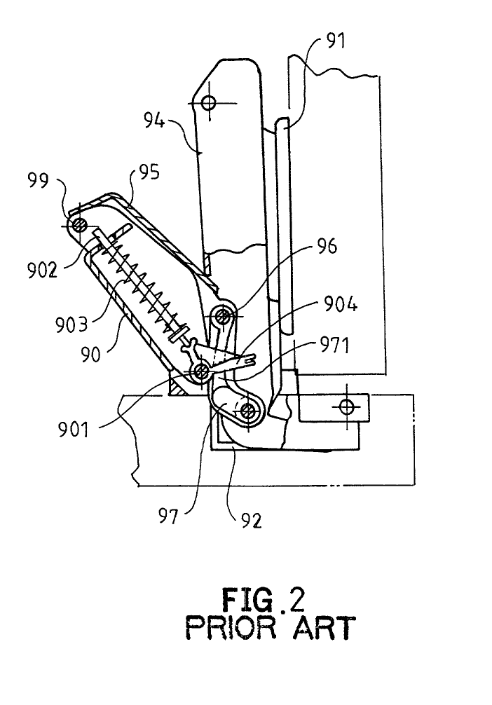

FIG. 3 is an exploded perspective view of a hinge device in accordance with the present invention.

FIG. 4 is a sectional view of the hinge device in accordance with the present invention in an open state.

FIG. 5 is a sectional view of the hinge device in accordance with the present invention in a closed state.

### DETAILED DESCRIPTION OF THE PREFERRED EMBODIMENT

A preferred embodiment in accordance with the present invention will now be described with reference to the accompanying drawings.

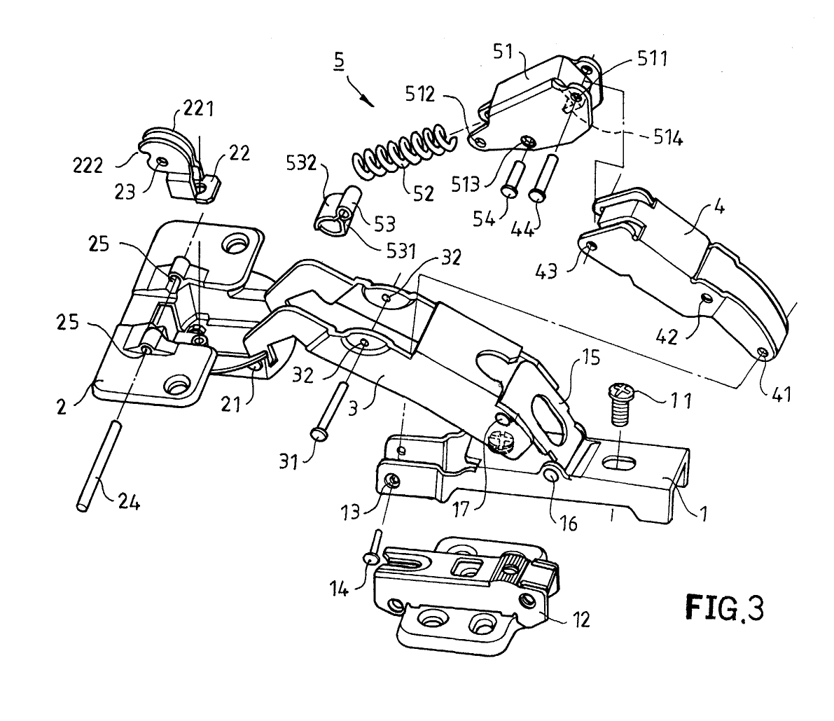

Referring to FIG. 3, a hinge device in accordance with the present invention generally includes a main plate 1, a mounting member 2, a first arm 3, a second arm 4, and a return device 5.

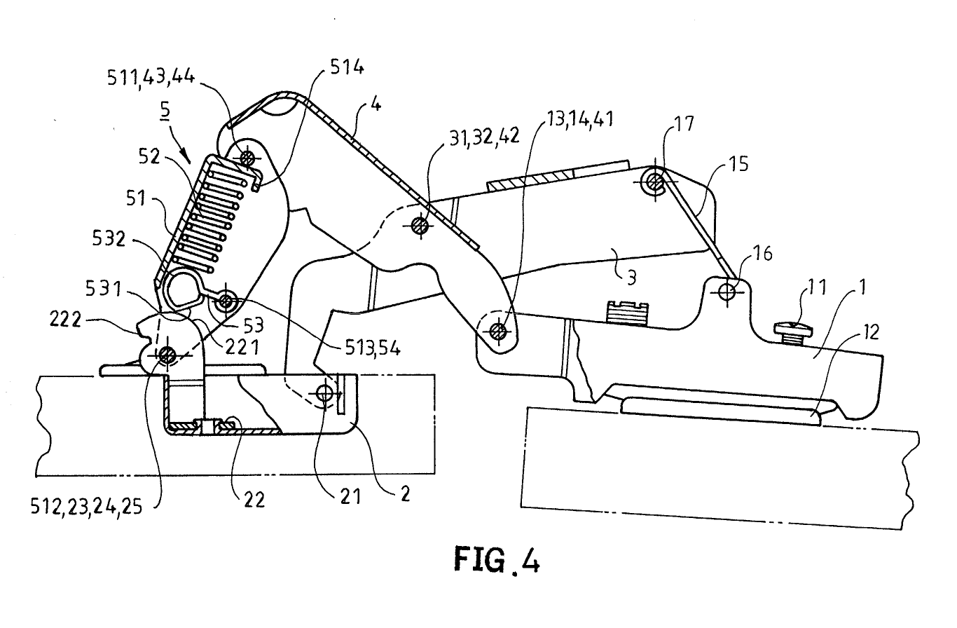

The main plate 1 is fixed by a fastener 11 to a mounting member 12, which, in turn, is generally fixed to a wall (not labeled, see FIG. 4) of furniture. A pivotal member 14 extends through a hole 13 in an end of the main plate 1 and a hole 4 in an end of the second arm 4. Another pivotal member 16 extends through an intermediate portion of the main plate 1 and an end of a connecting plate 15. A further pivotal member 17 extends through the other end of the connecting plate 15 and an end of the first arm 3.

The mounting member 2 is generally fixed to a doorplate (not labeled, see FIG. 4) of the furniture. The other end of the first arm 3 is pivoted by a pivotal member 21 to the mounting member 2. A positioning block 22 is mounted (e.g., riveted) to the mounting member 2 and includes a hole 23 aligned with a pair of positioning holes 25 in the mounting member 2. A pivotal member 24 extends through the holes 23 and 25, thereby further reliably fixing the positioning block 22. A top of the positioning block 22 includes a lobe 221 and a retaining groove 222 formed thereon.

An end of the first arm 3 is pivoted by the pivotal member 17 to an end of the connecting plate 15, and the other end of the first arm 3 is pivoted by the pivotal member 21 to the mounting member 2, as mentioned above. The first arm 3 and the second arm 4 are X-hinged together by a pivotal member 31.

An end of the second arm 4 is pivoted by the pivotal member 14 to the hole 13 of the main plate 1. The pivotal member 31 extends through a hole 42 in an intermediate portion of the second arm 4 and a hole 32 in an intermediate portion of the first arm 3. A pivotal member 44 extends through a hole 43 in the other end of the second arm 4 and a hole 511 in an end of a connecting member 51 of the return device 5.

The return device 5 includes the connecting member 51, an elastic element 52, and an engaging member 53. The connecting member 51 is substantially U-shaped and includes two symmetric sidewalls and a top plate. The above-mentioned hole 511 is defined in the sidewalls of the connecting member 51. In addition, the connecting member 51 includes an extension 514 between the sidewalls. The pivotal member 24 extends through a hole 512 in the other end of the connecting member 51 and aligned holes 25 in the mounting member 2, allowing the connecting member 51 to pivot relative to the positioning block 22 and the mounting member 2. Further, a pivotal member 54 extends through a hole 513 in the engaging member 53 and a hole (not labeled) of the engaging member 53. The engaging member 53 includes an eccentric lobe 532 and a protrusion 531. The elastic element 52 is mounted in the connecting member 51 and attached between the extension 514 of the connecting member 51 and the lobe 532 of the engaging member 53.

When the doorplate is in an open state shown in FIG. 4, the engaging member 53 is located on the lobe 221, and the elastic element 52 is compressed.

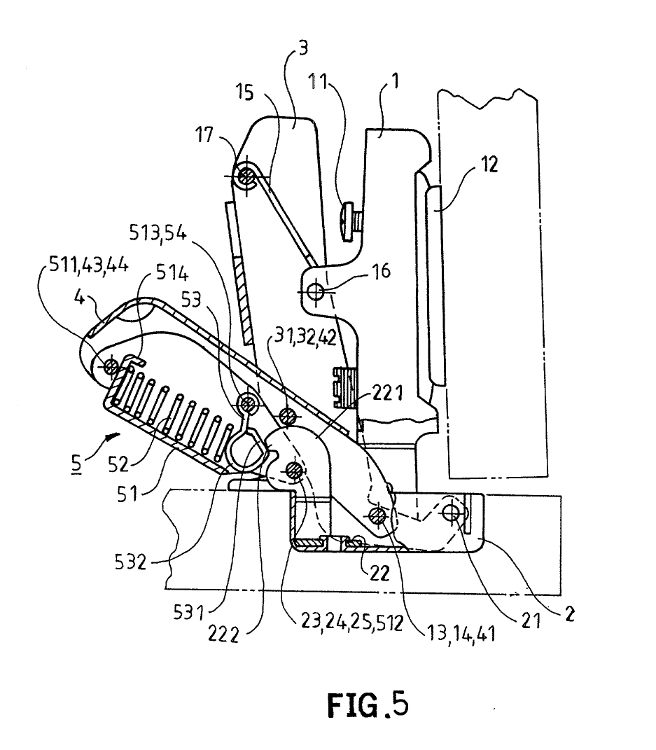

When the doorplate is moved to a closed state shown in FIG. 5, the protrusion 531 of the engaging member 53 slides into the retaining groove 222 of the positioning block 22, and the elastic element 52 is in an extended state. Thus, the protrusion 531 and the retaining groove 222 provide a reliable positioning effect.

When the hinge device in accordance with the present invention is mounted to furniture, since the engaging member 53 is biased by the elastic element 52 to be in sliding contact with the positioning block 22 and since the protrusion 531 of the engaging member 53 is engaged in the retaining groove 222 of the positioning block 22 when in the closed state, the doorplate can be reliably retained in place when in the closed state. Further, since the engaging member 53 is in sliding contact with the lobe 221 of the positioning block 22 and since the protrusion 531 of the engaging member 53 is reliably retained in the retaining groove 222 of the positioning block 22, the hinge device in accordance with the present invention is more durable and less likely to be damaged.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A hinge device comprising:
a main plate including an end and an intermediate portion;
a mounting member;
a connecting plate including a first end pivoted to the intermediate portion of the main plate and a second end;
a first arm including a first end pivoted to the second end of the connecting plate and a second end pivoted to the mounting member;
a second arm including a first end, a second end, and an intermediate portion, the intermediate portion of the second arm being pivoted to an intermediate portion of the first arm, the first end of the second arm being pivoted to the end of the main plate;
a positioning block fixed to the mounting member and including a lobe and a retaining groove; and
a return device comprising a connecting member, an elastic element, and an engaging member, the connecting member including a first end pivoted to the second end of the second arm, the connecting member further including a second end pivoted to mounting member, the engaging member being pivoted to an intermediate portion of the connecting member and including a lobe and a protrusion, the elastic element being attached between the connecting member and the lobe of the engaging member;
wherein when the hinge device is moved to an open state, the engaging member moves across the lobe of the positioning block, and wherein when the hinge device is in a closed state, the protrusion of the engaging member is engaged in the retaining groove of the positioning block.

2. The hinge device as claimed in claim 1, wherein the positioning block includes a hole, the mounting member including a pair of positioning holes aligned with the hole of the positioning block, further comprising a pivotal member extending through the positioning holes of the mounting member and the hole of the positioning block.

3. The hinge device as claimed in claim 1, wherein the connecting member includes an extension to which an end of the elastic element is attached.
